(19) United States
(12) Patent Application Publication
(10) Pub. No.: US 2007/0147020 A1
(43) Pub. Date: Jun. 28, 2007

(54) Lighting device including customized retarder and display device including same

(75) Inventors: Gary T. Boyd, Woodbury, MN (US); Robert M. Emmons, St. Paul, MN (US); Mark B. O'Neill, Stillwater, MN (US); Nicholas Roland, Oakdale, MN (US); Philip E. Watson, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/319,325

(22) Filed: Dec. 28, 2005

(51) Int. Cl. F21V 9/14

(52) U.S. Cl. 362/19

(57) ABSTRACT

Lighting devices are disclosed that include a light source, a circular reflective polarizer optically coupled to the light source, a back reflector configured and disposed to reflect light that has been reflected by the circular reflective polarizer back toward the input surface thereof, one or more optical elements having a total non-zero retardance Rs and disposed between the circular reflective polarizer and the back reflector, and a customized retarder. The customized retarder has a retardance Rc such that a total retardance of the one or more optical elements and the customized retarder, Rs+Rc, approaches nλ/2. The one or more optical elements, the customized retarder and the back reflector are characterized by a total depolarization of no more than 66%. Display devices including such lighting devices are also disclosed.

### FIELD OF THE INVENTION

The present invention relates to display devices and lighting devices including retarders and circular reflective polarizers.

### BACKGROUND

Microprocessor-based devices that include electronic displays for conveying information to a viewer have become nearly ubiquitous. Mobile phones, handheld computers, personal digital assistants, electronic games, car stereos and indicators, public displays, automated teller machines, in-store kiosks, home appliances, computer monitors, televisions and others are all examples of devices that include information displays viewed on a daily basis. Many of the displays provided on such devices are liquid crystal displays (“LCDs”).

Unlike cathode ray tube (CRT) displays, LCDs do not emit light and, thus, require a separate light source for viewing images formed on such displays. For example, a source of light can be located behind the display, which is generally known as a “backlight.” Some traditional backlights include one or more brightness enhancing films having linear prismatic surface structures, such as Vikuiti™ Brightness Enhancement Film (BEF), available from 3M Company. One or more reflective polarizer films are also typically included into a backlight, such as Vikuiti™ Dual Brightness Enhancement Film (DBEF) or Vikuiti™ Diffuse Reflective Polarizer Film (DRPF), both available from 3M Company. DBEF and/or DRPF transmit light with a predetermined polarization. Light with a different polarization is reflected back into the backlight, where the polarization state of that light is usually scrambled, e.g., with diffusers and other “random” polarization converting elements, and the light is fed back into the reflective polarizer. This process is usually referred to as “polarization recycling.”

### SUMMARY OF THE INVENTION

In one exemplary implementation, the present disclosure is directed to lighting devices including a light source and a circular reflective polarizer having an input surface optically coupled to the light source and an output surface disposed opposite the input surface. The circular reflective polarizer is configured to transmit at least a substantial amount of light having a first polarization state and reflect at least a substantial amount of light having a second polarization state different from the first polarization state. In addition, the lighting devices include a back reflector configured and disposed to reflect light that has been reflected by the circular reflective polarizer back toward the input surface thereof and one or more optical elements having a total non-zero retardance Rs and disposed between the circular reflective polarizer and the back reflector. The lighting devices further include a customized retarder having a retardance Rc such that a total retardance of the one or more optical elements and the customized retarder, Rs+Rc, approaches n λ/2. The one or more optical elements, the customized retarder and the back reflector are characterized by a total depolarization of no more than 66%.

In another exemplary implementation, the present disclosure is directed to lighting devices including a light source and a circular reflective polarizer having an input surface optically coupled to the light source and an output surface disposed opposite the input surface. The circular reflective polarizer is configured to transmit light having a first polarization state and reflect light having a second polarization state different from the first polarization state. In addition, the lighting devices include a back reflector configured and disposed to reflect light that has been reflected by the circular reflective polarizer toward the input surface thereof, a light distributing element disposed between the back reflector and the circular reflective polarizer having an input facet optically coupled to the light source and an output facet optically coupled to the input surface of the circular reflective polarizer, and one or more optical films disposed between the back reflector and the circular reflective polarizer. The light-distributing element and the one or more optical films have a non-zero total retardance Rs. The lighting devices further include a customized retarder having a retardance Rc such that the total retardance of the light-distributing element, the one or more optical films and the customized retarder, Rs+Rc, approaches n λ/2. The light-distributing element, the one or more optical films, the customized retarder and the back reflector are characterized by a total depolarization of no more than 66%.

In yet another exemplary implementation, the present disclosure is directed to lighting devices including a light source and a circular reflective polarizer having an input surface optically coupled to the light source and an output surface disposed opposite the input surface. The circular reflective polarizer is configured to transmit light having a first polarization state and reflect light having a second polarization state different from the first polarization state. In addition, the lighting systems include a back reflector configured and disposed to reflect light that has been reflected by the circular reflective polarizer toward the input surface thereof and one or more optical elements having a total non-zero in-plane retardance Rs and disposed between the back reflector and the circular reflective polarizer. The lighting systems further include a customized retarder disposed adjacent to the circular reflective polarizer and having an in-plane retardance Rc such that the total in-plane retardance, of the one or more optical elements and the customized retarder, Rs+Rc, approaches n λ/2. The one or more optical elements, the customized retarder and the back reflector are characterized by a total depolarization of no more than 66%.

These and other aspects of the lighting devices and display devices according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, wherein:

FIG. 1 is a schematic cross-sectional view of an exemplary display device and an exemplary lighting device constructed according to the present disclosure;

FIG. 2 is a schematic cross-sectional view of an exemplary display device and a lighting device constructed according to another exemplary embodiment of the present disclosure; and

FIG. 3 is a diagram illustrating some physical properties and design considerations of an exemplary lighting device constructed according to the present disclosure;

FIGS. 4-29 are plots showing calculated relative brightness of the configuration shown in FIG. 3 utilizing a linear polarizer, where the total retardance of the additional optical elements and the angle formed by the combined slow axis of the additional optical elements are varied.

### DETAILED DESCRIPTION

Performance of a display device, such as an LCD, is often judged by its brightness. Use of a larger number of light sources and/or of brighter light sources is one way of increasing brightness of a display. However, additional light sources and/or brighter light sources consume more energy, which typically requires allocating more power to the display device. For portable devices this may correlate to decreased battery life. Adding light sources to the display device or using brighter light sources may increase the cost and weight of the display device.

Another way of increasing brightness of a display device involves more efficiently utilizing the light that is available within the display device or within its lighting device such as a backlight. For example, light within a display device or a lighting device may be “polarization recycled” using a reflective polarizer, such that the reflective polarizer transmits at least a substantial amount of light having a desired polarization characteristic and reflects at least a substantial amount of light having a different polarization characteristic. The polarization of the reflected (i.e., rejected) light then may be altered by other elements in the lighting device and fed back to the reflective polarizer, whereupon the recycling sequence repeats.

Although the polarization recycling mechanism described above is very effective in providing a brighter display with the same power allocation, at least some light is usually lost with each repeating recycling sequence. For example, some light can be lost due to Fresnel reflections at the interfaces of the optical elements present in the display device and due to light absorption by the materials of the optical elements, the effects of which may become significant with multiple passes of light.

Accordingly, the present disclosure is directed to lighting devices, such as backlights, that include reflective polarizers and customized retarders and display devices including such lighting devices. Customized retarders included into exemplary embodiments of the present disclosure are intended to aid in reducing the number of recycling sequences by facilitating the conversion of the reflected/rejected polarization into polarization that can be transmitted by the reflective polarizer, as described in more detail below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

The term “polarization” refers to plane or linear polarization, circular polarization, elliptical polarization, or any other nonrandom polarization state in which the electric vector of the beam of light does not change direction randomly, but either maintains a constant orientation or varies in a systematic manner. With in-plane polarization, the electric vector remains in a single plane, while in circular or elliptical polarization, the electric vector of the beam of light rotates in a systematic manner.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The term “in-plane birefringence” is understood to be the difference between the in-plane indices (nₓ and n_{y}) of refraction. The term “out-of-plane birefringence” is understood to be the difference between one of the in-plane indices (nₓ or n_{y}) of refraction and the out-of-plane index of refraction n_{z}.

The retardance of a birefringent film is the phase difference introduced when light passes through a medium of a thickness (d), based on the difference in the speeds of advance of light polarized along the slow axis, which is the axis orthogonal to the light propagation direction and characterized by a larger value of the refractive index, and along the axis or direction normal thereto. In some exemplary embodiments utilizing oriented polymeric films at normal and nearly normal incidence of light, the slow axis is collinear with the direction in which the film is stretched, and thickness d becomes the thickness of the film. The retardance or retardation is represented by the product Δn*d, where Δn is the difference in refractive indexes along the slow axis and the direction normal thereto, and d is the medium thickness traversed by the light.

The term “in-plane retardation” refers to the product of the difference between two orthogonal in-plane indices of refraction times the thickness of the optical element.

The term “out-of-plane retardation” refers to the product of the difference of the index of refraction along the thickness direction (z direction) of the optical element and one in-plane index of refraction times the thickness of the optical element. Alternatively, this term refers to the product of the difference of the index of refraction along the thickness direction (z direction) of the optical element and the average of in-plane indices of refraction times the thickness of the optical element.

Those of ordinary skill in the art will readily appreciate that when light is incident at an angle with respect to a surface normal of a medium characterized by both in-plane and out-of-plane birefringences, the light encounters components of both the in-plane and the out-of-plane birefringences. Generally, retardance is a function of (i) the thickness of the optical element such as a film, (ii) nₓ, n_{y}, n_{z}, (iii) the angle of incidence of light, and (iv) the angle between the projection of the plane of incidence onto the film and the slow axis of the film. Calculation of the effective refractive indices and direction of refracted rays as functions of the angle of incidence for the case where the projection of the plane of incidence onto the film coincides with the slow axis of the film is considered by Brehat et al., J. Phys. D: Appl. Phys. 26 (1993) 293-301, the contents of which are hereby incorporated by reference herein. The general case, where the projection of the plane of incidence onto the film makes an angle with respect to the slow axis of the film, is considered by Simon M. C., J. Opt. Soc. Am. A 4 (1987) 2201, the contents of which are hereby incorporated by reference herein.

In any case, a person of ordinary skill in the art can determine optimum retardance for any given angle of incidence using commercially available software that allows one to simulate series of experiments to determine the effect of a birefringent film on polarization state of transmitted light. One example of such software is DIMOS brand software available from Autronic-Melchers GmbH.

Those of ordinary skill in the art will readily appreciate that when light is incident at an acute or obtuse angle at a medium characterized by both in-plane and out-of-plane birefringences, the light encounters components of both the in-plane and the out-of-plane retardations.

Lighting Devices and Display Devices

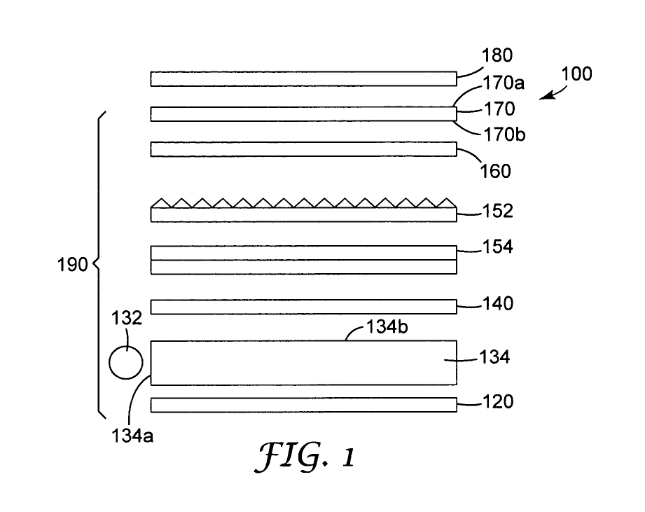

FIG. 1 shows an exemplary display device 100 including an exemplary lighting device 190 constructed according to the present disclosure, a display panel 180 and, optionally, one or more additional optical films and/or components (not shown) as desired for a particular application. Suitable display panels include liquid crystal display panels (LCD panels), such as twisted nematic (TN), single domain vertically aligned (VA), optically compensated birefringent (OCB) liquid crystal display panels and others. The display panel and the lighting device 190 are arranged such that the display panel 180 is disposed between the lighting device 190 and a viewer (not shown), such that the lighting device 190 supplies light to the display panel 180. In this exemplary embodiment, the lighting device 190 can be referred to as a backlight.

The exemplary lighting device 190 includes a reflective polarizer 170. The reflective polarizer 170 has a light input surface 170b and a light output surface 170a, and it is disposed such that the light output surface 170a faces the display panel 180. In some exemplary embodiments, the reflective polarizer 170 is a linear reflective polarizer. In other exemplary embodiments, the reflective polarizer 170 is a circular reflective polarizer. The reflective polarizer 170 transmits at least a substantial amount of light having a first polarization characteristic and reflects at least a substantial amount of light having a second polarization characteristic, different from the first polarization characteristic. Preferably, the reflective polarizer 170 transmits at least 50%, more preferably at least 70%, and even more preferably at least 90%, of light at normal incidence having the first polarization characteristic and transmits less than 50%, more preferably less than 30%, and even more preferably less than 10% of light at normal incidence having the second polarization characteristic. Examples of suitable reflective polarizers include but are not limited to circular reflective polarizers and elliptical reflective polarizers, which transmit light having polarization characterized by a first rotational orientation and reflect light having polarization having a second, different, rotational orientation. Exemplary circular reflective polarizers include cholesteric reflective polarizers.

Referring further to FIG. 1, the lighting device 190 further includes a back reflector 120 disposed on the side of the lighting device 190 that faces away from the display panel 180 and a customized retarder 160 (described in more detail below) disposed between the reflective polarizer 170 and the back reflector 120. In the exemplary embodiment illustrated in FIG. 1, the customized retarder 160 is located adjacent the input surface of the reflective polarizer, but that location can be changed depending on a particular application. For example, the customized retarder 160 can be disposed adjacent to the back reflector 120.

Suitable back reflectors include specular reflectors, such as mirrors. Suitable mirrors include, without limitation, metal-coated mirrors, such as silver-coated or aluminum-coated mirrors or mirror films, polymeric mirror films, such as multilayer polymeric reflective films. Other suitable back reflectors include diffuse reflectors and reflectors having both specular and diffuse reflectivity components. Diffuse reflectors include, but are not limited to particle-loaded plastic films, particle-loaded voided films and back-scattering reflectors. Reflectors having both specular and diffuse reflectivity components include, without limitation, specular reflectors coated with diffuse coatings, reflectors having a structured surface, reflectors with beaded coatings or while coatings.

The lighting device 190 also includes a light source 132 optically coupled to (i.e., is used to illuminate) the input surface 170b of the reflective polarizer 170. Any suitable light source or sources are within the scope of the present disclosure, for example, the light source 132 can be a broadband light source or a light source assembly or assemblies. Light sources suitable for use with the present disclosure include one or more CCFLs, LEDs or light source assemblies including LEDs. The light source 170 is preferably optically coupled to (i.e., is caused to enter) a light-distributing element 134, which in some exemplary embodiments can be a substantially planar or wedge-shaped solid or hollow lightguide. In such exemplary embodiments, light from the light source 132 is coupled (i.e., caused to enter) into an edge 134a of the light-distributing element 134 and, after propagating within the light-distributing element 134, e.g., via TIR, it is coupled (i.e., caused to exit) out through the output side 134b in the direction of the reflective polarizer 170. Although the exemplary embodiment shown in FIG. 1 illustrates one light source used in the display device 100 and lighting device 190, other exemplary embodiments can include two or more light sources or arrays of light sources. If more than one light source is used, one or more light sources may be disposed at different edges of the light-distributing element 134.

The lighting device 190 also includes one or more optical elements 152, 154 and 140 disposed between the reflective polarizer 170 and the back reflector 120. Exemplary additional optical films include, without limitation, structured surface films and one or more diffusers. Preferably, diffusers provided above the reflective polarizer 170 and the back reflector 120, e.g., diffuser 140, are polarization-preserving diffusers. In the exemplary lighting device 190, the additional optical elements include two structured surface films 152 and 154, both having linear prismatic surface structures disposed on the surfaces of the films 152 and 154 that face the reflective polarizer 170. Preferably, the direction of the linear prismatic surface structures of the optical film 152 is orthogonal to the direction of the linear prismatic surface structures of the optical film 154. In other exemplary embodiments, the cavity may include optical films having a structured surface including surface structures of any other useful shape.

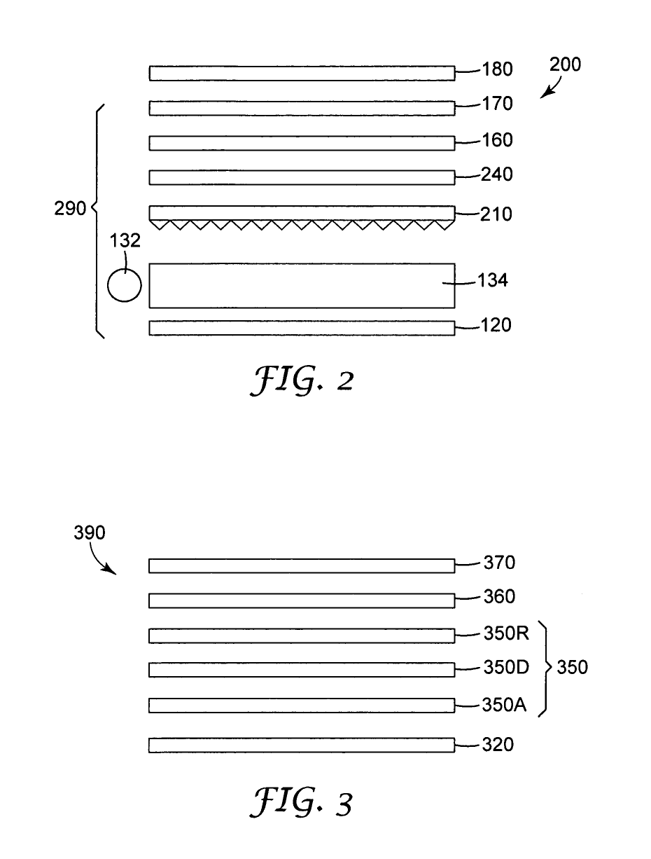

Other additional optical films may be used instead of or in addition to the optical films described above, depending on the application. For example, FIG. 2 shows a display device 200 including a lighting device 290 constructed according to the present disclosure and a display panel 180. The same reference numbers are used in FIG. 2 to refer to elements that are similar to those of FIG. 1. The lighting device 290 includes a diffuser 240 and a structured surface film 210, both disposed between the reflective polarizer 170 and the back reflector 120. In the exemplary lighting device 290, the structured surface film 240 includes linear prismatic surface structures disposed on the surface of the film 240 that faces the back reflector 120. Such structured surface films are sometimes referred to as turning films. In other exemplary embodiments, the structured surface film 290 may include surface structures of any other useful shape disposed on the surface of the film 240 that faces the back reflector 120.

During operation of the exemplary display devices shown in FIGS. 1 and 2, light coupled out of the output side 134b of the light-distributing element 134 and transmitted through the additional optical elements 152-140 and the customized retarder 160 is incident onto the input surface 170b of the reflective polarizer 170. The reflective polarizer 170 transmits at least a substantial portion of light having the first polarization state through its output surface 170b toward the display panel 180 and reflects at least a substantial portion of light having the second polarization state toward the back reflector 120. The reflected light passes through the customized retarder 160, the additional optical elements 152-140, the light-distributing element 134 and is then incident onto the back reflector 120. The back reflector 120, in turn, reflects at least a portion of (preferably, all or a substantial portion of) that light back toward the input surface 170b of the reflective polarizer 170.

Customized Retarders

As described above, the reflective polarizer 170 of the lighting devices 190 and 290 described above, reflects light with undesired polarization orientation toward the back reflector 120. In an ideal system having no optical elements between a circular reflective polarizer and the back reflector, the reflected light will change its polarization from the second rotational orientation to the first rotational orientation due to reflection at the back reflector. That light having the first rotational orientation can then be transmitted by the circular reflective polarizer. However, most practical optical systems include additional optical elements with a total non-zero in-plane and/or out-of-plane birefringence, which results in total-non-zero retardance experienced by the light passing through such additional optical elements. In such optical systems, the optimum performance characterized by high relative brightness may be improved by addition of a customized retarder that aids in converting the reflected polarization to the polarization having the opposite rotational orientation.

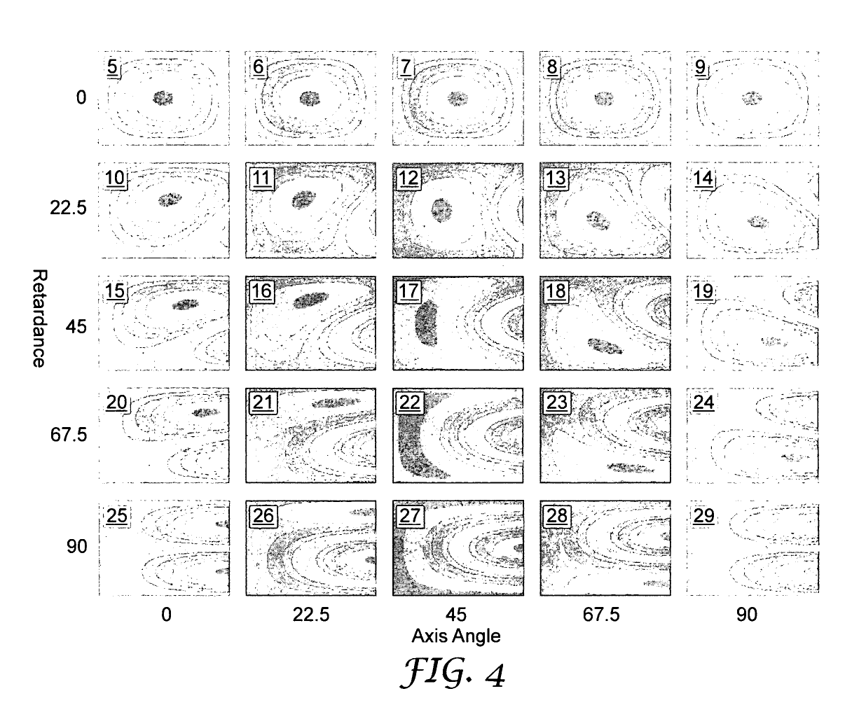

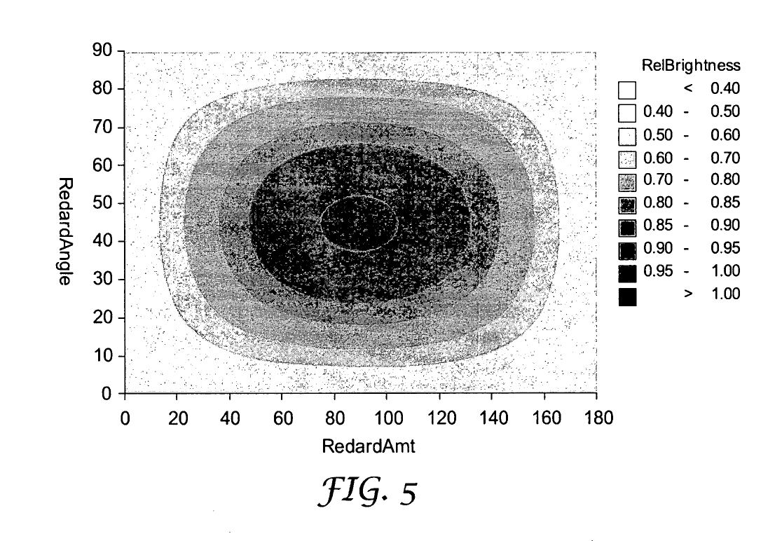

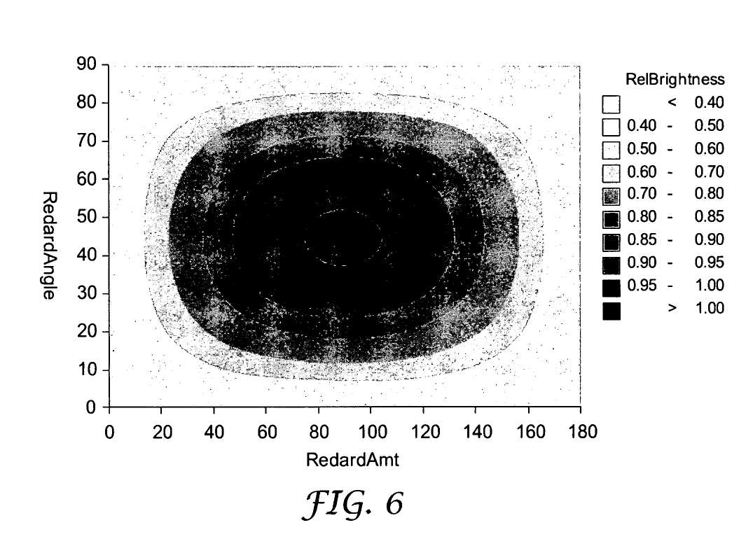

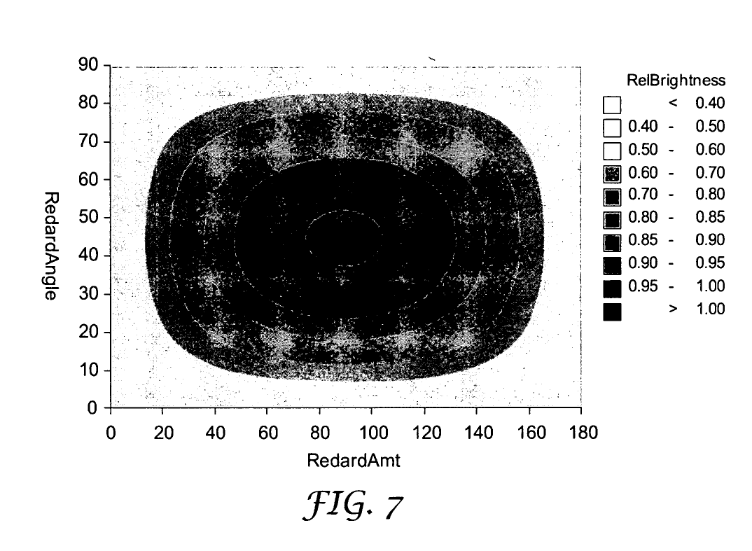

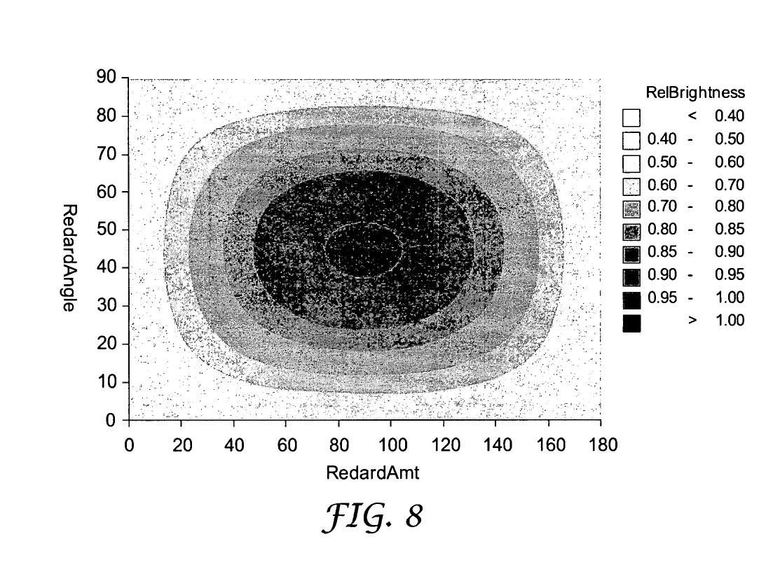

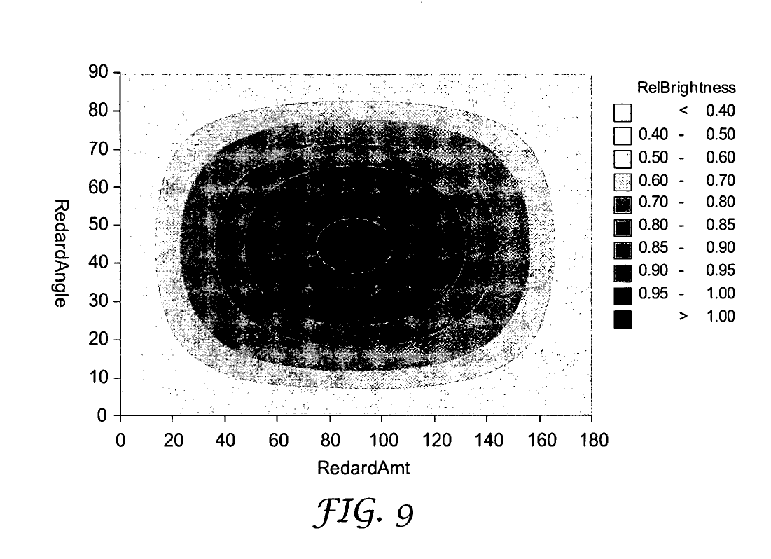

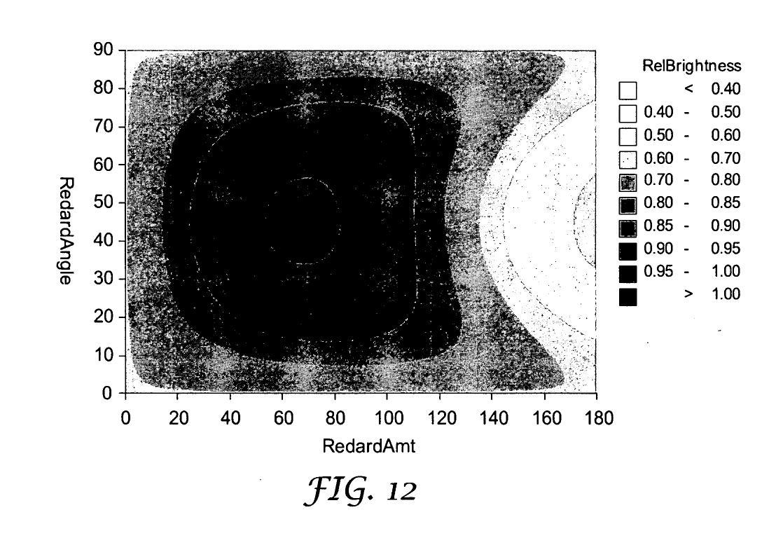

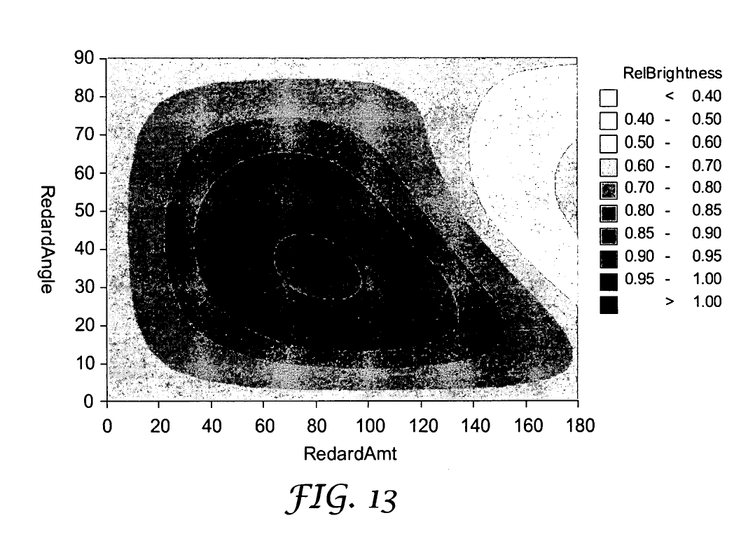

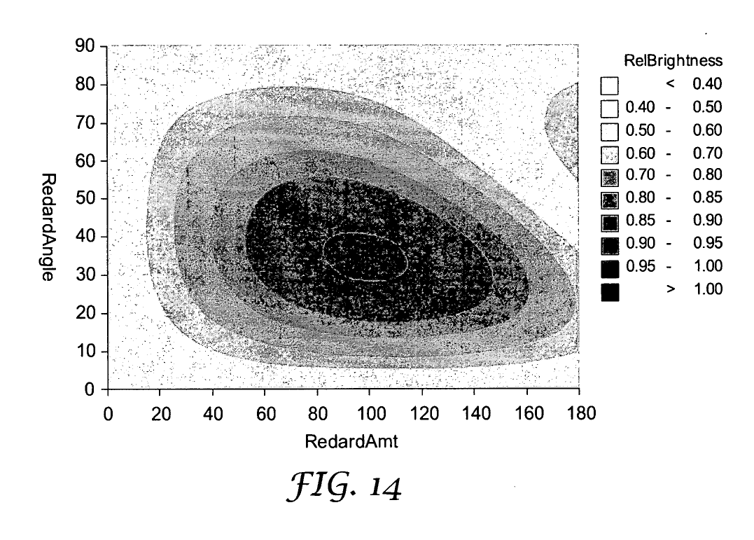

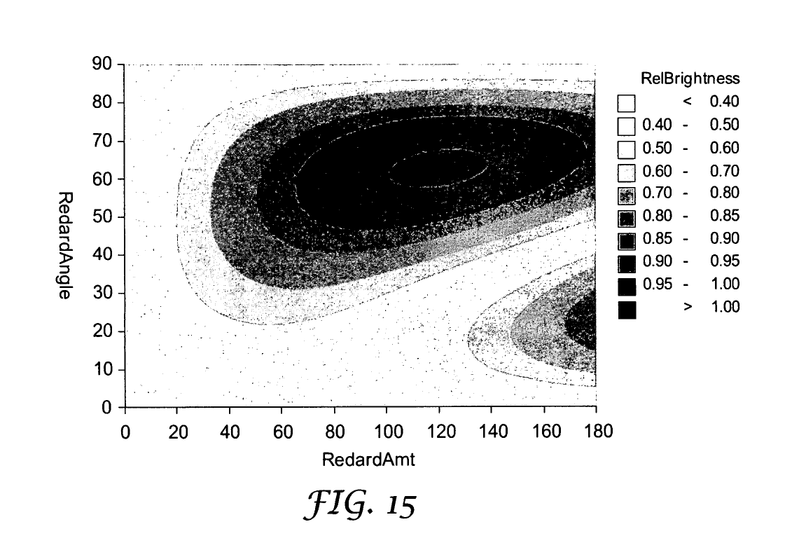

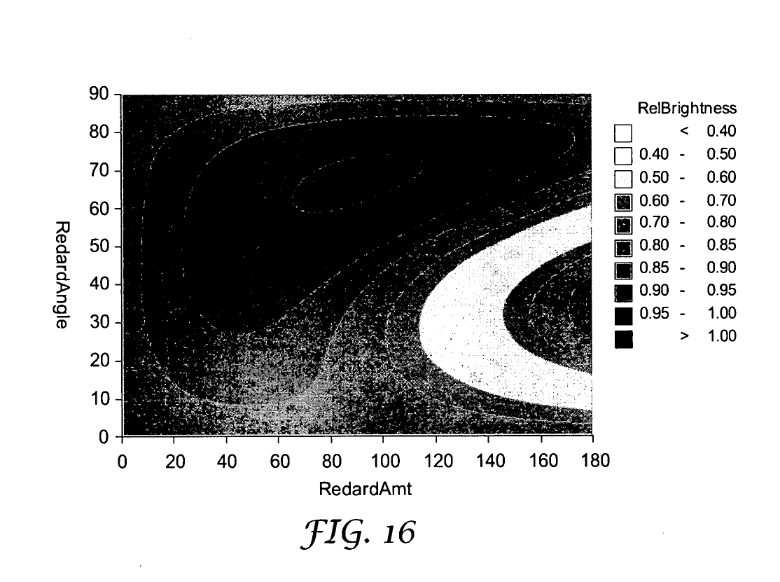

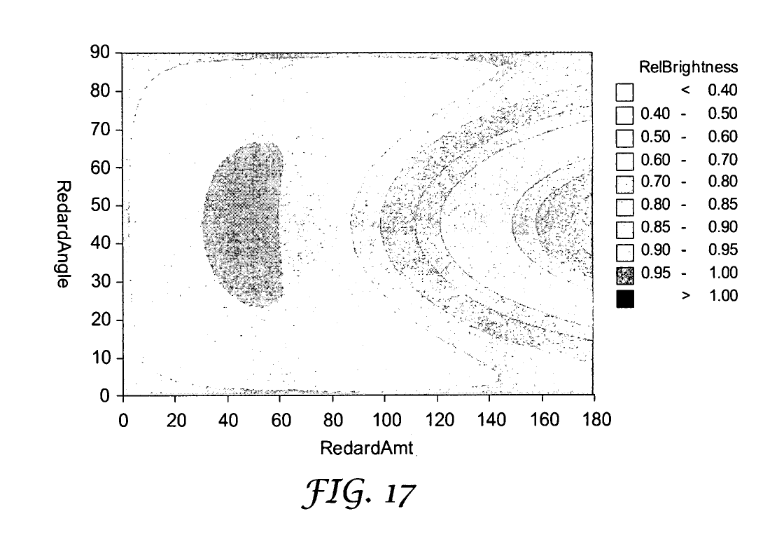

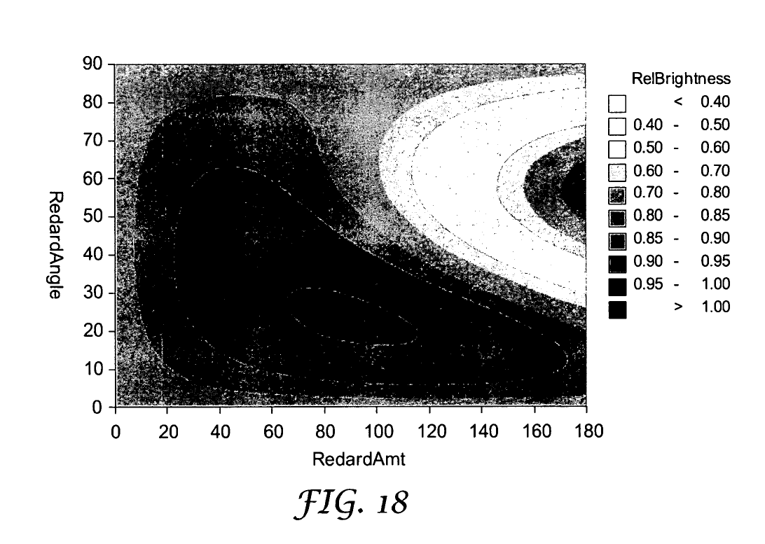

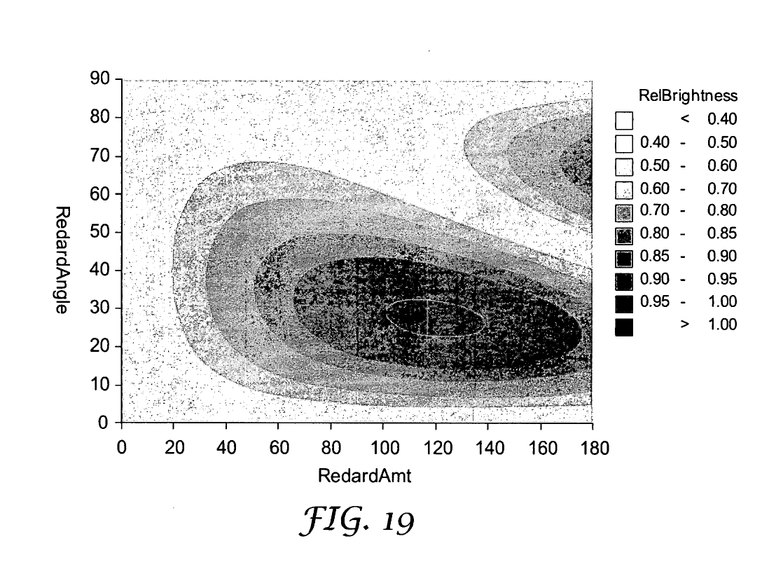

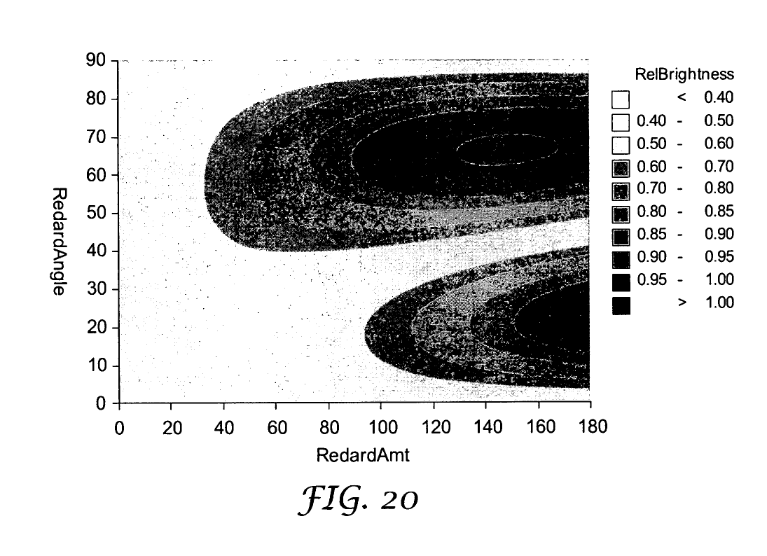

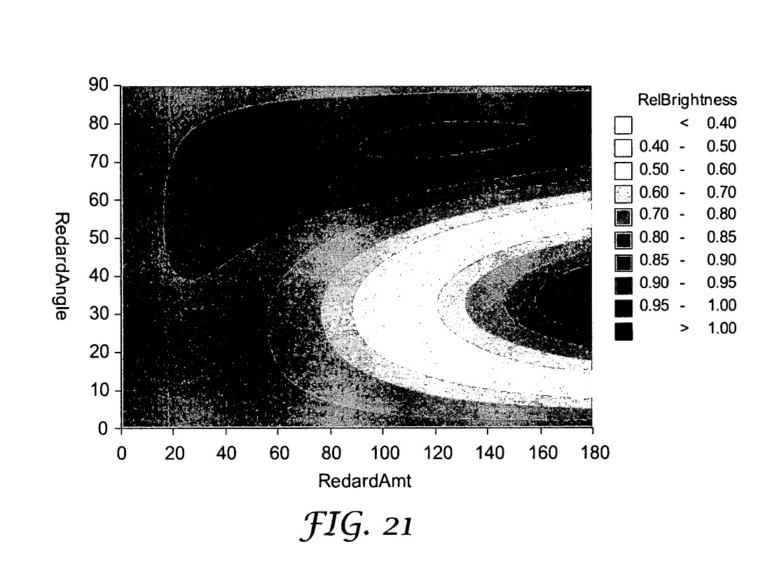

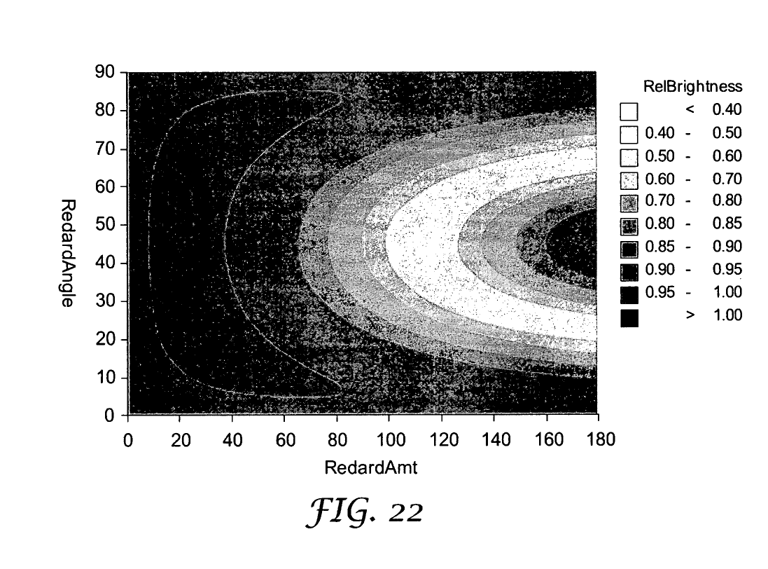

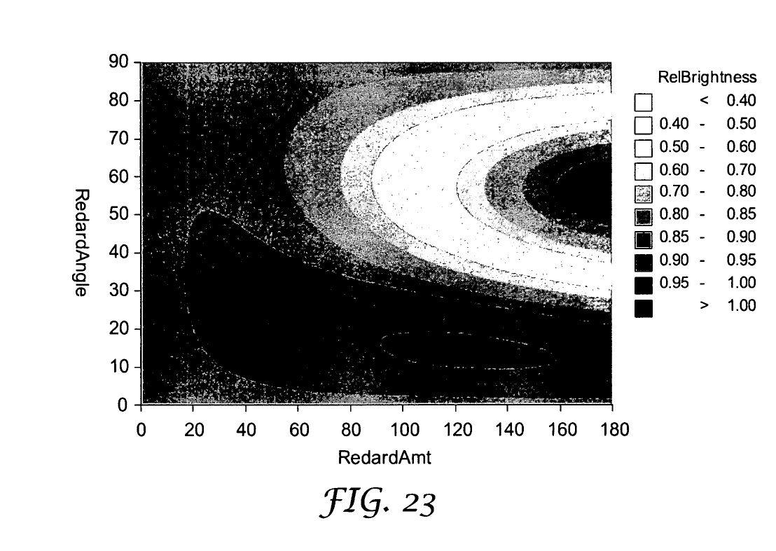

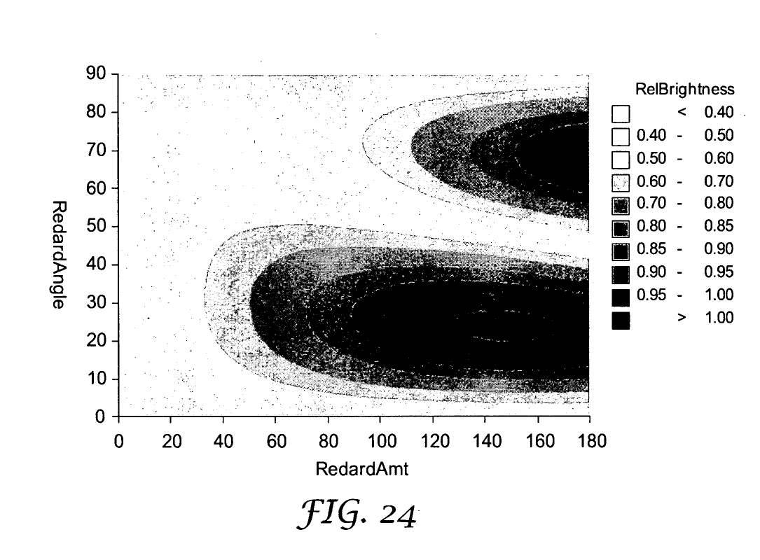

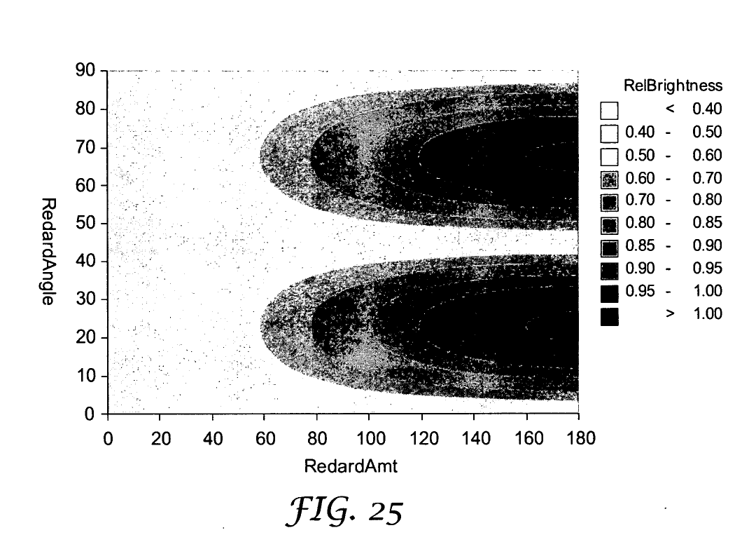

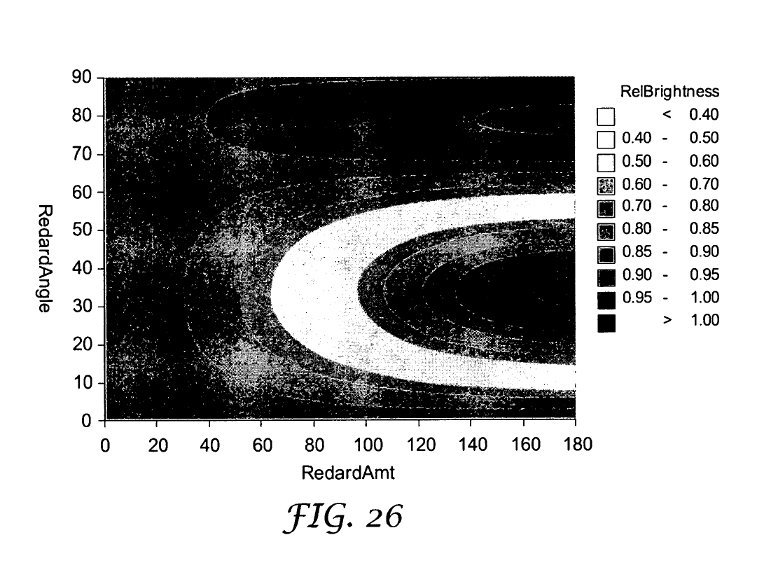

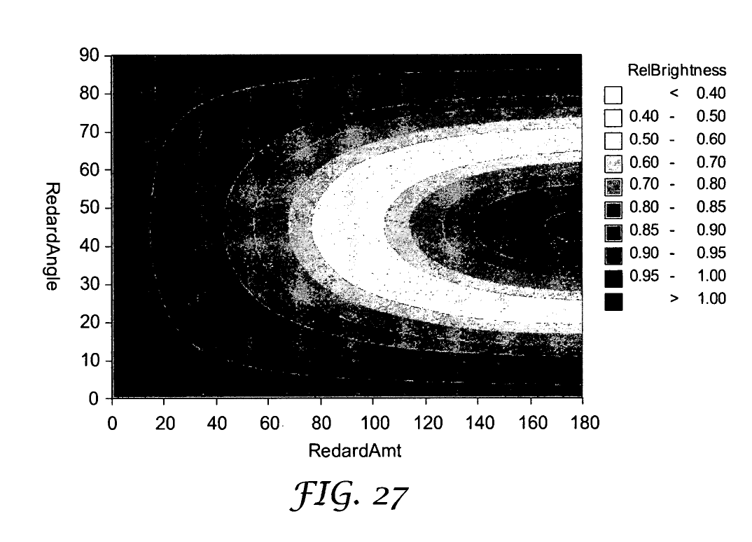

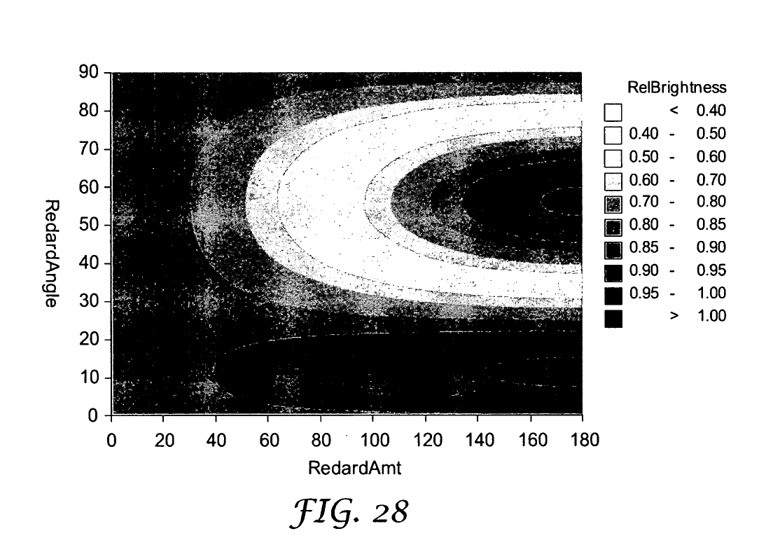

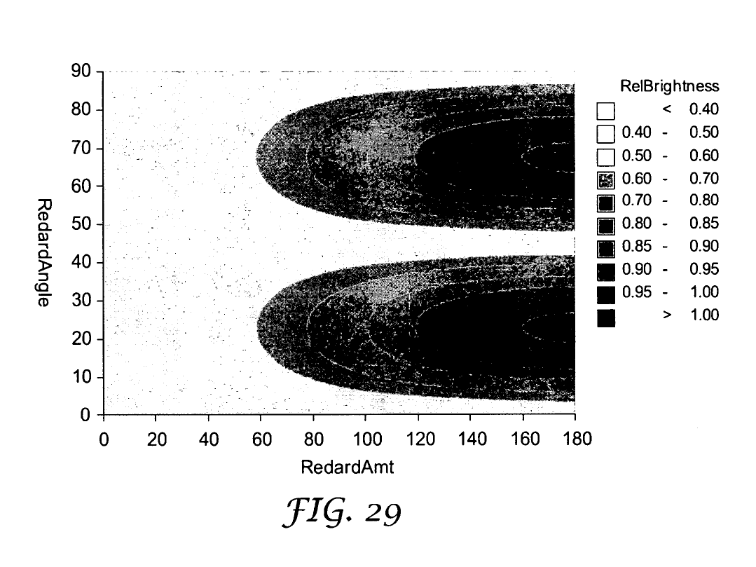

This situation is illustrated in FIGS. 4-29, which show plots of calculated relative brightness of the configuration shown in FIG. 3 utilizing a linear polarizer, where the total retardance of the additional optical elements and the angle formed by the combined slow axis of the additional optical elements are varied. Although the data shown in these plots of relative brightness were generated for systems with linear reflective polarizers, the same plots can be used to illustrate the workings of an optical system utilizing a circular reflective polarizer simply by shifting the horizontal and vertical axes of the individual plots, i.e., FIGS. 5-29 by −90°.

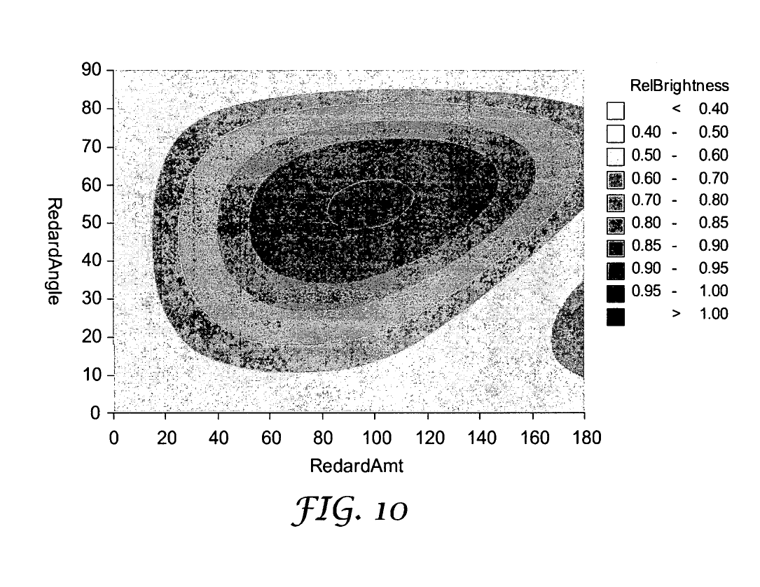

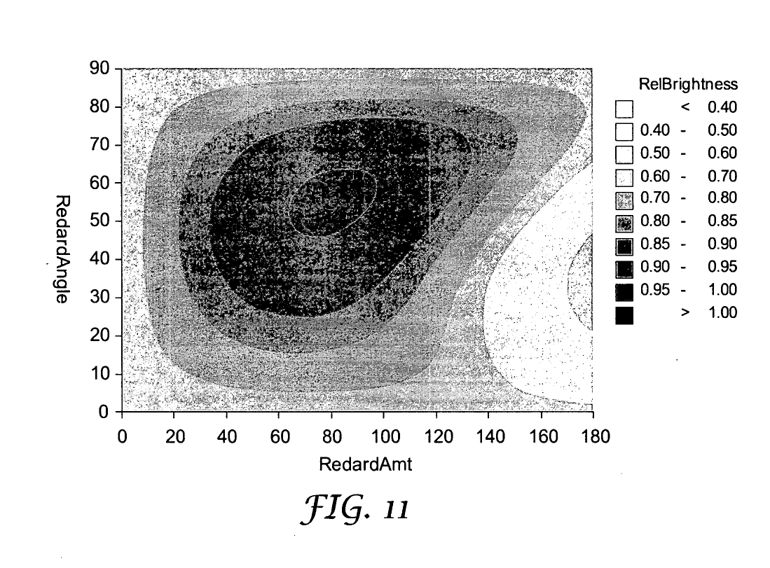

The ideal system is represented by the top row of modeled plots shown in FIG. 4 and, in more detail, by FIGS. 5-9. There, the retardance of the additional optical elements is zero, which results in the maximum relative brightness for a customized retarder with retardance of zero. Performances of practical lighting systems including an additional optical element with non-zero retardance are illustrated by the second through fifth rows of the modeled plots shown in FIG. 4, and, in more detail, in FIGS. 10-29. One may observe from these plots that as the total retardance of the additional optical element departs from zero, the optimum performance characterized by high relative brightness is achieved with a customized retarder of non-zero retardance. Accordingly, typical embodiments of the present disclosure that utilize circular reflective polarizers include a customized retarder such that the total retardance (Rc+Rs) of the optical elements disposed in the lighting device 190 or 290 between the back reflector 120 and the reflective polarizer 170 (Rs) and that of the customized retarder (Rc) approaches nλ/2, where λ is the wavelength of interest and n=0, ±1, ±2, 3 . . . .

In some exemplary embodiments, two or more birefringent additional optical elements may be present in a lighting device such as a backlight. In some such exemplary embodiments, the two or more birefringent additional optical elements may have slow axes disposed at an angle with respect to each other. In such exemplary lighting systems, it may be advantageous to use a customized retarder that includes two or more retarder films, each retarder film having an optical axis disposed at an angle with respect to the slow axis of another retarder film.

For example, the lighting device may include a first birefringent optical element having a first slow axis and a second birefringent optical element having a second slow axis, the first slow axis disposed at an angle with respect to the second slow axis. In this exemplary lighting device the customized retarder comprises a first retarder film having a first retarder slow axis and a second retarder film having a second retarder slow axis, the first retarder slow axis disposed at an angle with respect to the second retarder slow axis.

Other exemplary embodiments may include only one birefringent additional optical element or one optical element that has very high birefringence, while birefringence of other optical elements is negligible. In such exemplary embodiments, a single film customized retarder may be used. A single film customized retarder may also be used where two or more birefringent additional optical elements have slow axes that are aligned with respect to each other. Single film customized retarders also may be used in exemplary lighting devices where optical properties of the one or more birefringent additional optical elements can be approximated as optical properties of a single linear retarder. Those of ordinary skill in the art will understand that other exemplary embodiments are within the scope of the present disclosure.

Generally, λ is the middle or average wavelength of the most useful or any desired (see my comments in the other document about lamba) wavelength range of the illumination source. For example, when one or more CCFLs are used as the illumination source, is the middle wavelength λ of the desired wavelength range (about 400 to about 700 nm) is about 555 nm. In other exemplary embodiments using light sources characterized by other wavelength ranges, λ can have a different value. For a monochromatic light source, λ is the illumination wavelength. In yet other exemplary embodiments, λ is the middle or average wavelength of a useful or desirable wavelength sub-range of the illumination source.

The total retardance (Rc+Rs) of the optical elements disposed in the lighting device 190 or 290 between the back reflector 120 and the reflective polarizer 170 (Rs) and that of the customized retarder (Rc) can be optimized for any desired angle of incidence. In some exemplary embodiments, the total retardance should be optimized in the direction of the maximum brightness, which typically is the intended viewing direction of the device, but, generally, the retardance can be optimized in any direction. For example, if light traverses the lighting device at angles at or about 90 degrees with respect to the plane of the films in the lighting device, total in-plane birefringence of the optical elements will have the greatest effect and should be optimized. However, for other angles, both the in-plane and out-of plane total birefringences of the optical elements will contribute to the total retardation experienced by light that traverses the lighting device. For example, in some lighting devices and displays, where the customized retarder is disposed between the back reflector and a turning film, both the in-plane and out-of-plane retardance components of the retardance Rc should be optimized for an angle at which a substantial portion of light enters the turning film. In some exemplary embodiments, that angle will be about 75 degrees=/−10 degrees. (see my comments in the other document about angles).

The customized retarders of the present disclosure are suited for use in lighting devices that also include at least one optical element having non-zero retardance disposed between the reflective polarizer and the back reflector. In some exemplary embodiments, the total retardance of the one or more additional optical elements is λ/16 or more, λ/8 or more, λ/4 or more, 3λ/8 or more or λ/2 or more.

FIG. 3, used to generate the plots of FIGS. 4-29, illustrates these and some other physical characteristics of exemplary lighting devices of the present disclosure. More particularly, FIG. 3 shows schematically a lighting device 390, which includes a reflective polarizer 370, a customized retarder 360 having a retardance Rc, additional optical elements 350 and a back reflector 320. The residual retardation Rs of this optical system without the customized retarder 360 is represented by the element 350R, which is also referred to above as retardance of the one or more additional optical elements. Depolarization experienced by light passing through the lighting device 390 is represented by the element 350D.

Depolarization of light may be caused by the back reflector and/or other optical elements. Depolarization is defined as percentage of randomly polarized light in the output beam that has been converted from polarized input beam of light. In typical embodiments of the present disclosure, the amount of depolarization due to the optical elements disposed between the reflective polarizer 370 and the back reflector, for a single pass of light, is no more than 66%, preferably no more than 41%, and more preferably no more than 24%. Absorption of light in the optical elements disposed between the reflective polarizer 370 and the back reflector 320, or by the reflector itself, is represented by the element 350A. In typical embodiments of the present disclosure, the amount of absorption for a single pass of light is at least 10% or at least 20%. The customized retarders of the present disclosure are expected to be particularly useful in lighting devices with large amounts of absorption.

As mentioned above, FIG. 4 shows modeled relative brightness contour plots for a system shown schematically in FIG. 3, with a specular back reflector and system absorption of 10% for a single pass of light. All retardance values are also calculated for a single pass of light. The following Table I contains some modeled data derived from the data used to generate the plots of FIGS. 4-29. More particularly, Table I shows the retardance(s) Rc of the customized retarder and the angle(s) between its slow axis and the pass axis of the reflective polarizer that results in maximum calculated relative brightness for a particular non-zero system retardance Rs and a particular slow axis orientation of the system with respect to the pass axis of the linear reflective polarizer. The amounts of retardance are shown in degrees (representing phase shift) and can be converted into fractions of λ according to the formula: (angle in degrees)/360*λ. Orientations of the slow axes are also provided in degrees.

TABLE I

| | | | Customized retarder | Maximum |
|---|---|---|---|---|
| | System slow axis | | slow axis | Relative |
| Rs | orientation | Rc - 90° | orientation(s) - 90° | Brightness |
| 22.5 | 0 | 94 | 64-65 | 0.905 |
| | | 96-100 | 64-66 | |
| | | 102 | 65-67 | |
| 22.5 | 22.5 | 76 | 63-65 | 0.905 |
| | | 78-80 | 63-67 | |
| | | 82 | 64-67 | |
| | | 83 | 65-67 | |
| 22.5 | 45 | 64 | 43-47 | 0.905 |
| | | 66-70 | 42-48 | |
| | | 72 | 45 | |
| 22.5 | 67.5 | 76 | 35-37 | |
| | | 78-80 | 33-37 | |
| | | 82 | 33-36 | |
| | | 83 | 33-35 | |
| 22.5 | 90 | 94 | 35-36 | 0.905 |
| | | 96-100 | 34-36 | |
| | | 102 | 33-35 | |
| 45 | 0 | 116-124 | 72-73 | 0.905 |
| 45 | 22.5 | 84-96 | 76-78 | 0.905 |
| 45 | 45 | 42 | 40-50 | 0.905 |
| | | 44-46 | 38-52 | |
| | | 48 | 39-51 | |
| 45 | 67.5 | 84-96 | 22-24 | 0.905 |
| 45 | 90 | 116-124 | 27-28 | 0.905 |
| 67.5 | 0 | 144-154 | 66-67 | 0.905 |
| 67.5 | 22.5 | 116-134 | 86-87 | 0.905 |
| 67.5 | 45 | 18 | 42-48 | 0.905 |
| | | 20 | 33-57 | |
| | | 22 | 29-61 | |
| | | 24 | 26-64 | |
| | | 26 | 24-66 | |
| | | 28 | 23-67 | |
| | | 30 | 22-29 and 61-68 | |
| | | 32 | 22-25 and 65-68 | |
| 67.5 | 67.5 | 116-134 | 13-14 | 0.905 |
| 67.5 | 90 | 144-154 | 23-24 | 0.905 |
| 90 | 0 | 176-180 | 67-68 | 0.905 |
| | | | 22-23 | |
| 90 | 22.5 | 170-180 | 78-79 | 0.905 |
| | | 176-180 | 33-34 | |
| 90 | 45 | 0-4 | Any | 0.905 |
| | | any | 0-1 or 89-90 | |
| | | 176-180 | 44-46 | |
| 90 | 67.5 | 176-180 | 56-57 | 0.905 |
| | | 170-180 | 11-12 | |
| 90 | 90 | 176-180 | 67-68 | 0.905 |
| | | | 22-23 | |

Exemplary optical elements suitable for use as customized retarders according to the present disclosure include, without limitation, polymeric retarders, e.g., oriented polymeric retarders, liquid crystal polymer retarders, e.g., lyotropic liquid crystal retarders, and any number or combination thereof. More particularly, exemplary customized retarders may include a simultaneously biaxially stretched polymer film layer that is non-absorbing and non-scattering for at least one polarization state of visible light, which have an in-plane retardance with an absolute value of 100 nm or less and an out-of plane retardance of 50 nm or more. Some optical films suitable for use as customized retarders are described in U.S. Application Publication Nos. 2004/0156106 and 2004/0184150, the disclosures of which are hereby incorporated by reference herein. Customized retarders may be extruded, solvent cast or produced by another method.

Those skilled in the art will readily observe that numerous modifications and alterations of the exemplary embodiments of the present disclosure may be made while retaining the teachings of the invention. For example, in any of the exemplary embodiments of the present disclosure, the components illustrated may be disposed at different locations within the lighting device than those shown. Any two or more components may be laminated to each other as may be desired for a particular application. Accordingly, the above disclosure should be construed as limited only by the metes and bounds of the appended claims.

What is claimed is:

1. A lighting device comprising:
a light source;
a circular reflective polarizer having an input surface optically coupled to the light source and an output surface disposed opposite the input surface, the circular reflective polarizer being configured to transmit at least a substantial amount of light having a first polarization state and reflect at least a substantial amount of light having a second polarization state different from the first polarization state;
a back reflector configured and disposed to reflect light that has been reflected by the circular reflective polarizer back toward the input surface thereof;
one or more optical elements having a total non-zero retardance Rs and disposed between the circular reflective polarizer and the back reflector;
a customized retarder having a retardance Rc such that a total retardance of the one or more optical elements and the customized retarder, Rs+Rc, approaches n λ/2;
wherein the one or more optical elements, the customized retarder and the back reflector are characterized by a total depolarization of no more than 66%.

2. The lighting device of claim 1, wherein the one or more optical elements include at least one of: a structured surface film and a diffuser.

3. The lighting device of claim 1, wherein the back reflector is a specular reflector.

4. The lighting device of claim 1, wherein the one or more optical elements, the customized retarder and the back reflector are characterized by a total depolarization of no more than 41%.

5. The lighting device of claim 1, wherein Rs is λ/8 or more.

6. The lighting device of claim 1, wherein the one or more optical elements, the customized retarder and the back reflector are characterized by a total absorption of at least 10%.

7. A display device comprising a lighting device according to claim 1 and a display panel optically coupled to the output surface of the circular reflective polarizer.

8. The lighting device of claim 1, wherein the one or more optical elements include a first birefringent optical element having a first slow axis and a second birefringent optical element having a second slow axis, the first slow axis disposed at an angle with respect to the second slow axis, and wherein the customized retarder comprises a first retarder film having a first retarder slow axis and a second retarder film having a second retarder slow axis, the first retarder slow axis disposed at an angle with respect to the second retarder slow axis.

9. A lighting device comprising:
a light source;
a circular reflective polarizer having an input surface optically coupled to the light source and an output surface disposed opposite the input surface, the circular reflective polarizer being configured to transmit light having a first polarization state and reflect light having a second polarization state different from the first polarization state;
a back reflector configured and disposed to reflect light that has been reflected by the circular reflective polarizer toward the input surface thereof;
a light distributing element disposed between the back reflector and the circular reflective polarizer having an input facet optically coupled to the light source and an output facet optically coupled to the input surface of the circular reflective polarizer and one or more optical films disposed between the back reflector and the circular reflective polarizer, wherein the light-distributing element and the one or more optical films have a non-zero total retardance Rs;
a customized retarder having a retardance Rc such that the total retardance of the light-distributing element, the one or more optical films and the customized retarder, Rs+Rc, approaches n λ/2;
wherein the light-distributing element, the one or more optical films, the customized retarder and the back reflector are characterized by a total depolarization of no more than 66%.

10. The lighting device of claim 9, wherein the one or more optical films include at least one of: a structured surface film and a diffuser.

11. The lighting device of claim 9, wherein the back reflector is a specular reflector.

12. The lighting device of claim 9, wherein the one or more optical films, the customized retarder and the back reflector are characterized by a total depolarization of no more than 41%.

13. The lighting device of claim 9, wherein Rs is λ/8 or more.

14. The lighting device of claim 9, wherein the one or more optical films, the customized retarder and the back reflector are characterized by a total absorption of at least 10%.

15. A display device comprising a lighting device according to claim 9 and a display panel optically coupled to the output surface of the circular reflective polarizer.

16. The lighting device of claim 9, wherein the one or more optical films include a first birefringent optical film having a first slow axis and a second birefringent optical film having a second slow axis, the first slow axis disposed at an angle with respect to the second slow axis, and wherein the customized retarder comprises a first retarder film having a first retarder slow axis and a second retarder film having a second retarder slow axis, the first retarder slow axis disposed at an angle with respect to the second retarder slow axis.

17. A lighting device comprising:
a light source;
a circular reflective polarizer having an input surface optically coupled to the light source and an output surface disposed opposite the input surface, the circular reflective polarizer being configured to transmit light having a first polarization state and reflect light having a second polarization state different from the first polarization state;
a back reflector configured and disposed to reflect light that has been reflected by the circular reflective polarizer toward the input surface thereof;
one or more optical elements having a total non-zero in-plane retardance Rs and disposed between the back reflector and the circular reflective polarizer;
a customized retarder disposed adjacent to the circular reflective polarizer and having an in-plane retardance Rc such that the total in-plane retardance, of the one or more optical elements and the customized retarder, Rs+Rc, approaches n λ/2
wherein the one or more optical elements, the customized retarder and the back reflector are characterized by a total depolarization of no more than 66%.

18. The lighting device of claim 17, wherein the one or more optical elements include at least one of: a structured surface film and a diffuser.

19. The lighting device of claim 17, wherein the back reflector is a specular reflector.

20. The lighting device of claim 17, wherein the one or more optical elements, the customized retarder and the back reflector are characterized by a total depolarization of no more than 41%.

21. The lighting device of claim 17, wherein Rs is λ/8 or more.

22. The lighting device of claim 17, wherein the one or more optical elements, the customized retarder and the back reflector are characterized by a total absorption of at least 10%.

23. A display device comprising a lighting device according to claim 17 and a display panel optically coupled to the output surface of the circular reflective polarizer.

24. The lighting device of claim 17, wherein the one or more optical elements include a first birefringent optical element having a first slow axis and a second birefringent optical element having a second slow axis, the first slow axis disposed at an angle with respect to the second slow axis, and wherein the customized retarder comprises a first retarder film having a first retarder slow axis and a second retarder film having a second retarder slow axis, the first retarder slow axis disposed at an angle with respect to the second retarder slow axis.
